(19) United States
(12) Patent Application Publication
(10) Pub. No.: US 2009/0125338 A1
(43) Pub. Date: May 14, 2009

(54) METHOD OF INSURING A LOTTERY TICKET

(76) Inventor: Timothy Elliott, East Dubuque, IL (US)

Correspondence Address: ZARLEY LAW FIRM P.L.C., CAPITAL SQUARE, 400 LOCUST, SUITE 200, DES MOINES, IA, 50309-2350, US

(21) Appl. No.: 11/938,460

(22) Filed: Nov. 12, 2007

(51) Int. Cl. G06Q 40/00; G06Q 90/00

(52) U.S. Cl. 705/4

(57) ABSTRACT

A method of insuring a lottery ticket. The method includes providing an option on a lottery ticket to purchase insurance to use the same numbers presented on the ticket in future drawings. Specifically, with the purchase of the insurance if you would forget to purchase a ticket for a subsequent drawing wherein the numbers were winning numbers the consumer would receive a payout representing a portion of the winning jackpot by virtue of having the insurance.

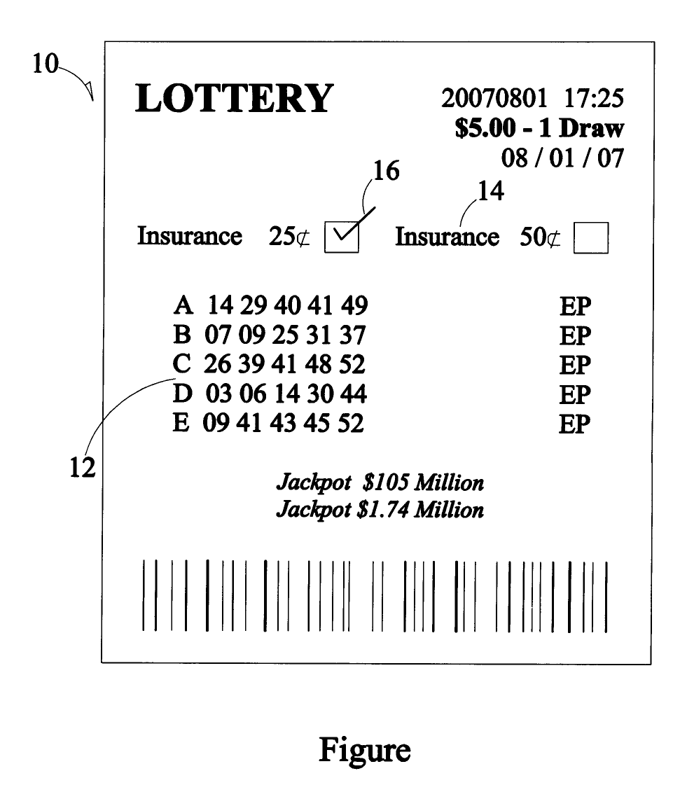

### BACKGROUND OF THE INVENTION

This invention relates to lotteries. More specifically, this invention relates to a method of insuring a lottery ticket.

States and multi states have provided a lottery for their citizens for many years. Specifically, lotteries require an individual to pick a certain amount of predetermined numbers and then during a lottery drawing numbers are chosen wherein if the predetermined numbers are identical to those chosen a consumer receives a predetermined prize such as a cash prize. There are many different philosophies in choosing numbers for the lottery including receiving a quick pick ticket wherein a lottery ticket machine provides a consumer with a selection of numbers randomly selected by the machine. Alternatively, an individual can play their own chosen set of numbers. Oftentimes individuals that choose their own numbers use the same numbers week in and week out.

Typically, lotteries like for example only, Powerball® has multiple drawings per week. Because lottery tickets are only sold at certain locations often individuals are unable to purchase lottery tickets at times when they desire to play the lottery. As a result, individuals may miss weeks wherein they purchase a ticket for a drawing. On occasion individuals that play the same numbers every drawing that forget or neglect to buy a ticket during one of the drawings have their numbers chosen thus missing out on their lottery prize.

Therefore, a principle object of the present is to provide a method of insuring lottery tickets to prevent missed drawing opportunities.

These and other objects, features, or advantages of the present invention will become apparent from the specification and claims.

### BRIEF SUMMARY OF THE INVENTION

A method of insuring a lottery ticket. The method includes providing a lottery ticket for a consumer. At the time of purchase, insurance on the lottery ticket is offered for the consumer such that if a consumer would like insurance an indication element associated with the lottery ticket is made. Then, if upon selection of predetermined numbers on the ticket during a lottery drawing a consumer with the insurance may provide the ticket in order to receive an insurance payout.

### BRIEF DESCRIPTION OF THE DRAWINGS

The figure is a top plan view of a lottery ticket.

### DETAILED DESCRIPTION OF THE PREFERRED EMBODIMENT

The figure shows a lottery ticket 10 used in association with a method of insuring said lottery ticket 10. The lottery ticket 10 has a plurality of predetermined numbers 12 thereon such that if the numbers are selected in a lottery drawing the ticket is considered a winning ticket as is conventional in the art. The lottery ticket 10 additionally thereon has an indication element 14 that can be provided with a mark 16 or other indicia. In a preferred embodiment as shown in the figure the indication element is a check box next to wording that indicates insurance has been provided wherein the mark 16 is merely a check. While shown as a box with a check the indication element could be a variety of items and could provide information such as the amount of insurance provided.

For example, the machine that produces the lottery ticket produces a mark or an individual may manually place a mark in a box. Similarly, the indication element 14 does not have to be physically on the lottery ticket but merely needs to be associated with the lottery ticket 10 to identify that the ticket has been insured.

In operation, an individual that desires to purchase a lottery ticket 10 goes to a lottery vendor. The vendor provides a lottery ticket to the consumer and provides them an option of receiving insurance on the lottery ticket. If the consumer decides they would like to purchase insurance for the lottery ticket they inform the vendor of their desire and the vendor then makes an indication element 14 associated with the lottery ticket to show the consumer has chosen the insurance.

Then, once an initial drawing takes place, if an individual does not win during that drawing, in a second drawing that takes place at a later date if the numbers picked at the second lottery drawing match with the predetermined numbers 12 chosen for the first lottery drawing, the consumer receives an insurance payout regardless if they had purchased a new ticket for the second drawing with the same numbers or not. Specifically, even if they did purchase a new ticket with the same numbers not only do they receive the insurance payout but additionally they receive their prize for having the winning numbers. Thus, by having the insurance if an individually forgets to play their numbers or cannot get to the store to buy a ticket they are insured that they at least receive a portion of what they would have won if they had gone to the store and played.

Regarding the payout, the ticket may be insured for any percentage of the winning jackpot; however, preferably the amount of the insurance is less than and merely a percentage of the winning jackpot. Furthermore, the insurance can be purchased at a price less than the original ticket such as 25 percent or 50 percent of the ticket price and as a result only a percentage of the jackpot would need to be paid. As a result, lottery insurance jackpots could grow at a faster rate than actual lottery jackpots because of the percentages generating more money dollar for dollar so that paying the insurance would not be a problem. Specifically, the odds of winning on the insurance play are identical to the odds of winning during the original play.

Additionally, insurance money does not necessarily have to be its own or be kept in a separate account or fund. It could be combined or added to the existing jackpot and all winners could be paid accordingly depending on the individual lottery percentages and rules. Alternatively, the money could be kept in an account separately by creating a separate fund. Thus, this would not affect the amount of the twice weekly drawing or the payout.

Also, an option exists wherein a block of insurance could be purchased. For example, a player could purchase a block of insurance such as six months or 48 draws worth of insurance. This information could be printed onto the ticket as part of the indication element and would serve as the holder's policy. Anytime throughout the next 48 draws if the player would forget or decide not to play a particular date and time as long as their ticket shows the winning numbers and proper identifying information they would be entitled to the insurance.

It will be appreciated by those skilled in the art that other various modifications could be made to the device without departing from the spirit and scope of this invention. All such modifications and changes fall within the scope of the claims and are intended to be covered thereby.

What is claimed is:

1. A method of insuring a lottery ticket steps comprising:
providing a lottery ticket for a consumer;
providing insurance on the lottery ticket for the consumer;
making an indication element associated with the lottery ticket to show the consumer has chosen to purchase the insurance; and
providing the consumer with an insurance payout upon selection of predetermined numbers in a lottery drawing.

2. The method of selling of claim 1 wherein the indication element is indicia on the lottery ticket.

3. The method of selling of claim 2 wherein the indicia on the lottery ticket is a box that is checked.

4. The method of selling of claim 2 wherein the indicia on the lottery ticket is a manual mark.

5. The method of selling of claim 1 wherein the lottery drawing is a second lottery drawing after an initial lottery drawing.

6. The method of selling of claim 1 wherein the insurance payout is less than the lottery ticket.
